(19) United States
(12) Patent Application Publication
(10) Pub. No.: US 2003/0105929 A1
(43) Pub. Date: Jun. 5, 2003

(54) Cache status data structure

(76) Inventors: Sharon M. Ebner, Mountain View, CA (US); John A. Wickeraad, Granite Bay, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 09/560,908

(22) Filed: Apr. 28, 2000

(51) Int. Cl. G06F 12/08

(52) U.S. Cl. 711/144; 711/145

(57) ABSTRACT

A cache status data structure in a cache memory system provides a large amount of status data, which various requesters, e.g., processors and I/O devices, may read, modify and/or write to, in order to allows flexibility in the manner in which the various requesters access the cache memory. The cache status data structure is implemented as a cache structure block having a plurality of cache status bits for each cache line of the cache memory. The cache status block comprises one or more read port and one or more write port, from which, upon presenting the line entry number of the cache line of interest, a requester may read and/or write back modified status bits. The cache status bits in the cache data structure includes include a significant amount of information, including, e.g., the owner of the cache line if any, the type of ownership, portions of the cache line which may be available to be accessed and the like, from which a requester may formulate the most suitable manner of accessing the cache memory based on the needs of the requester and the current status of the cache line of interest.

### TECHNICAL FIELD

The invention relates to computer processors and memory systems. More particularly, the invention relates to an arbitration of accesses to a cache memory.

### BACKGROUND ART

Processors nowadays are more powerful and faster than ever. So much so that even memory access time, typically in tens of nanoseconds, is seen as an impediment to a processor running at its full speed. Typical CPU time of a processor is the sum of the clock cycles used for executing instructions and the clock cycles used for memory access. While modern day processors have improved greatly in the Instruction execution time, access times of reasonably priced memory devices have not similarly improved.

A common method to hide the memory access latency is memory caching. Caching takes advantage of the antithetical nature of the capacity and speed of a memory device. That is, a bigger (or larger storage capacity) memory is generally slower than a small memory. Also, slower memories are less costly, thus are more suitable for use as a portion of mass storage than are more expensive, smaller and faster memories.

In a caching system, memory is arranged in a hierarchical order of different speeds, sizes and costs. For example, a smaller and faster memory—usually referred to as a cache memory—is placed between a processor and a larger, slower main memory. The cache memory may hold a small subset of data stored in the main memory. The processor needs only a certain, small amount of the data from the main memory to execute individual instructions for a particular application. The subset of memory is chosen based on an immediate relevance, e.g., likely to be used in the near future based on the well known “locality” theories, i.e., temporal and spatial locality theories. This is much like borrowing only a few books at a time from a large collection of books in a library to carry out a large research project. Just as research may be as effective and even more efficient if only a few books at a time were borrowed, processing of an application program is efficient if a small portion of the data was selected and stored in the cache memory at any one time.

Particularly, an Input/output (I/O) cache memories may have different requirements from processor caches, and may be required to store more status information to for each cache line than a processor cache, e.g., to keep track of the identity of the one of many I/O devices requesting access to and/or having ownership of a cache line. The identity of current requester/owner of the cache line may be used, e.g., to provide a fair access (i.e., to prevent starvation of any of the requesters). Moreover, an I/O device may write to only a small portion of a cache line. Thus, an I/O cache memory may be required to store status bits indicating which part of the cache line has been written, or which part of the cache line has been fetched.

A conventional cache memory generally includes a small number of status bits with each line of data (hereinafter referred to as a “cache line”), e.g., most commonly, a valid bit that indicates whether the cache line is currently in use or if it is empty, and a dirty bit indicating whether the data has been modified.

Prior implementations of status of cache memory also include a state machine implementation, in which there are a small finite number of states to indicate the status of the cache line. For example, a conventional state machine may include up to six states, each indicating whether the line is empty, valid and dirty, etc.

Unfortunately, however, the conventional cache status bits and state machines are limited in the amount of information that can be conveyed, and are thus grossly inadequate for use in an I/O cache. The small number of status bits and state machines in a conventional cache system do not allow various ways in which the cache memory may be accessed, and thus restricts I/O devices in the way the cache may be accessed. The conventional cache systems cannot accommodate any new innovative cache accessing protocols that may be devised by I/O device developers, and thus hinders the progress of technology.

Moreover, in an I/O cache system that requires much more cache status information, it would be more efficient and flexible to provide a cache status information data structure that is a “data-path” type structure from which a number of requesters, e.g., I/O devices, may examine and modify status of cache lines in order to access the cache lines in the most efficient manner as determined by the requesters themselves. It would be also preferable to allow concurrent access to the cache lines by a number of requesters, e.g., to allow several requesters to snoop, read and/or write different cache lines simultaneously. To this end, the status information must also be available to be read, modified and/or written to by several requesters concurrently. The conventional small number of status bits or states are typically implemented as control logic signals, and thus do not lend themselves to be easily read, modified and/or written to by the requesters, much less allowing a concurrent access thereto.

Furthermore, a conventional state machine approach, as the amount of information (and thus the number of states) becomes large, is difficult to design and implement. Since all of the possible transitions between the states must be taken into account, the design os often “bug-prone”. Further, as the size of the cache memory becomes large, the state machine to account for the large number of states per cache line becomes large, and thus the size of the state logic becomes too big to be practical to implement, e.g., integrated circuit.

Thus, there is a need for more efficient method and device for providing a cache status data structure, from which a large amount of information can be provided to allow a flexible cache access to requesters of the cache lines in a cache memory.

### SUMMARY OF INVENTION

In accordance with the principles of the present invention, a method of providing cache status information of a plurality of cache lines in a cache memory comprises providing a cache status data table having a plurality of status entries, each of the plurality of status entries corresponding to one of the plurality of cache lines in the cache memory, and each of the plurality of cache status entries having a plurality of cache status bits that indicates status of the corresponding one of the plurality of cache lines, receiving a first cache entry line number corresponding to a first one of the plurality of cache lines from a first requester, and allowing the first requester an access to a first requested one of the plurality of status entries that corresponds to the first cache entry line number.

In addition, in accordance with the principles of the present invention, an apparatus for providing cache status information of a plurality of cache lines in a cache memory comprises a cache status datatable having a plurality of status entries, each of the plurality of status entries corresponding to one of the plurality of cache lines in the cache memory, and each of the plurality of cache status entries having a plurality of cache status bits that indicates status of the corresponding one of the plurality of cache lines, means for receiving a first cache entry line number corresponding to a first one of the plurality of cache lines from a first requester, and means for allowing the first requester an access to a first requested one of the plurality of status entries that corresponds to the first cache entry line number.

In accordance with another aspect of the principles of the present invention, a cache memory system comprises a cache memory having a plurality of cache lines, a cache status data table having a plurality of status entries, each of the plurality of status entries corresponding to one of the plurality of cache lines in the cache memory, and each of the plurality of cache status entries having a plurality of cache status bits that indicates status of the corresponding one of the plurality of cache lines.

### DESCRIPTION OF DRAWINGS

Features and advantages of the present invention will become apparent to those skilled in the art from the following description with reference to the drawings, in which:

FIG. 1 is a block diagram of the relevant portions of an exemplary embodiment of the cache memory system in accordance with the principles of the present invention;

FIG. 2 is an illustrative table showing relevant portions of a cache status data table in accordance with an embodiment of the present invention; and

FIG. 3 is flow diagram illustrative of an exemplary embodiment of the cache access process in accordance with an embodiment of the principles of the present invention.

### DETAILED DESCRIPTION OF PREFERRED EMBODIMENTS

In accordance with the principles of the present invention, a cache status data structure in a cache memory system provides a large amount of status data, which various requesters, e.g., processors and I/O devices, may read, modify and/or write to, in order to allows flexibility in the manner in which the various requesters access the cache memory. The cache status data structure is implemented as a cache structure block having a plurality of cache status bits for each cache line of the cache memory.

The cache status block comprises one or more read port and one or more write port, from which, upon presenting the line entry number of the cache line of interest, a requester may read and/or write back modified status bits. The cache status bits in the cache data structure includes include a significant amount of information, including, e.g., the owner of the cache line if any, the type of ownership, portions of the cache line which may be available to be accessed and the like, from which a requester may formulate the most suitable manner of accessing the cache memory based on the needs of the requester and the current status of the cache line of interest.

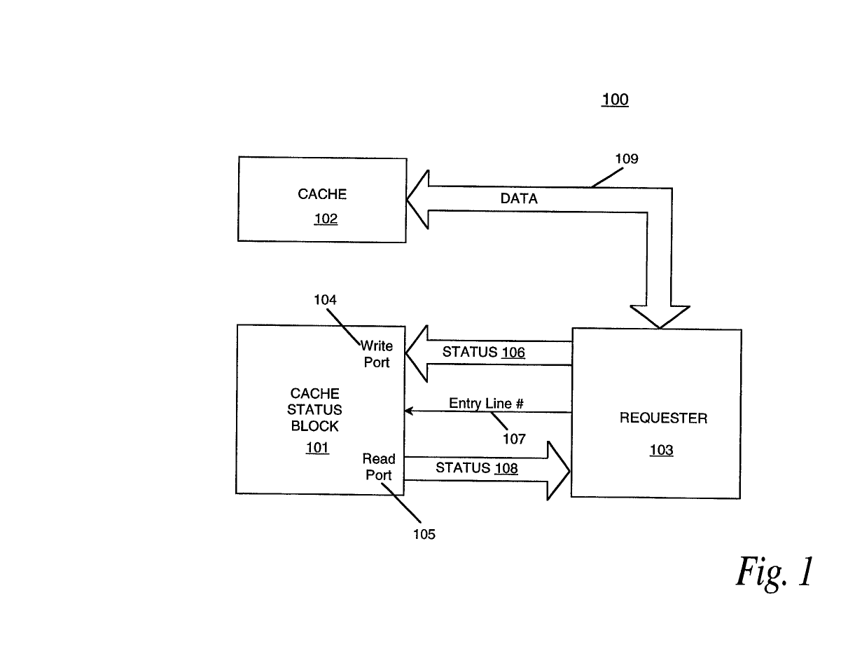

In particular, FIG. 1 shows an exemplary embodiment of the cache memory system 100 in accordance with the principles of the present invention, which comprises a cache memory 102, and a cache status block 101. The cache status block 101 may be implemented as a memory device having one or more read ports 104 and one or more write ports 105 to allow a requester 103 to read and/or write to one of a plurality of cache status bits stored in the cache status block 101.

When a requester, e.g., the requester 103, presents the cache status block 101 with a entry line number 107 corresponding to one of a plurality of cache lines in the cache memory 102, the cache status bits for that cache line may be read from the read port 105 and/or the same cache status bits may be written to through the write port 104. The requester may examine the cache status bits to determine the most suitable manner in which to access the cache line from the cache memory 102 through the data bus 109.

Although only one read port and one write port are shown in this example, in a preferred embodiment of the present invention, the cache status block 101 comprises a multi-port memory devices having any number of read ports and write ports to enable several requesters to concurrently access the cache status information from the cache status block 101. A requester 103 may be any entity in a computing system that may request access to the cache memory 102, and may include, e.g., processors, input output (I/O) devices, direct memory access (DMA) controller and the like.

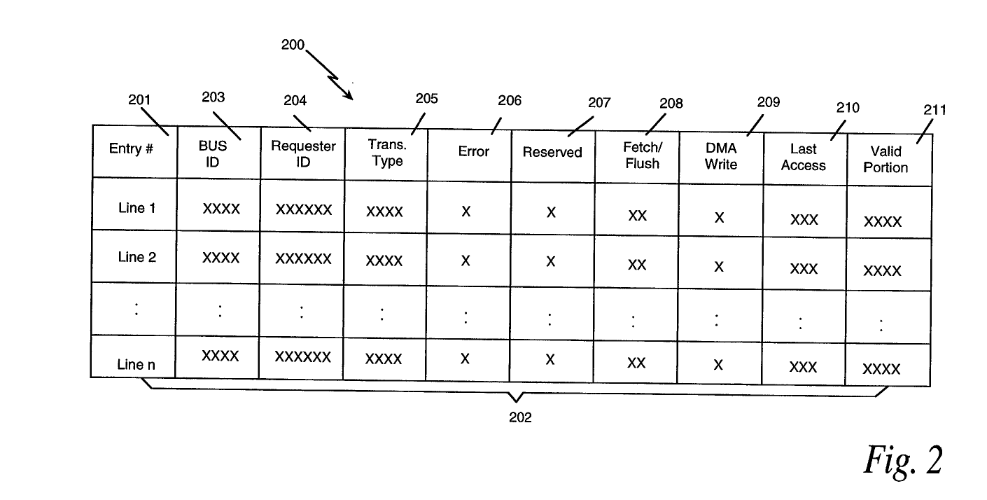

In a preferred embodiment of the present invention, the cache status block 101 may have stored therein the cache status bits in a cache status data table 200 as shown in FIG. 2. As shown, the cache status data table 200 comprises a plurality of status entries each containing a large number of status bits, e.g., forty (40) bits. Each of status entries has a one-to-one correspondence to one of the cache lines in the cache memory 102.

As shown in FIG. 2, the cache status data table 200 comprises a plurality of status entries corresponding to each of cache lines, e.g., line 1 through line n. By way of an example, and not as a limitation, each of status entries may comprise a number of status bits to indicate, e.g., the identity of the I/O bus (BUS ID 203), in a multiple I/O bus system, accessing the cache line corresponding to the status entry, and the identity of the requestor (Requester ID 204), e.g., the actual I/O device accessing the cache line through the I/O bus. Each status entry may further include Trans Type 205 bits indicating the types of ownership, e.g., “shared” or “private”, of the corresponding cache line, an error bit 206 indicating that a fetch error has occurred, a reserved bit 207 indicating that the cache line is scheduled to be used in the near future, and bits indicating which part of the data is valid (Valid Portion 211). Other bits may indicate if functions are in progress on the cache line, e.g., a fetch or flush (Fetch/Flush 208), or if a DMA write is pending to the cache line (DMA Write 209). The“Last Access” bits 210 may indicate the time the cache access was last accessed to be used for implementing a replacement strategy.

Optionally, some critical bits can be implemented outside of the structure, for instances where the bits for all cache lines need to be accessed at once. An example is the valid bit, which indicates if a line is in use. All valid bits may need to be visible to select the next empty line available for use on a cache miss.

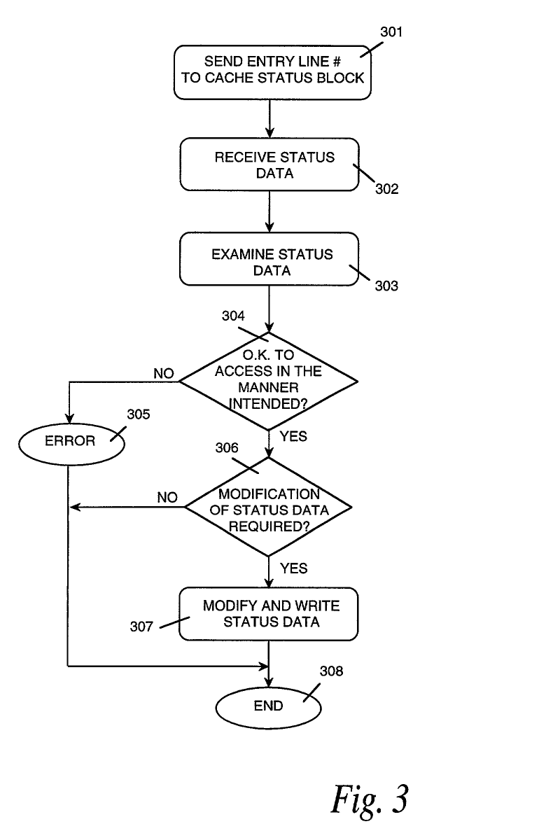

The inventive cache access process will now be described with references to FIG. 3. In accordance with an embodiment of the present invention, when a requester desires to access a cache line, the requester 103 sends a entry line number 107 to the cache status block 101 instep 301. In step 302, in response to the presented cache entry line number 107, the cache status block 101 makes available at the read port 105 the status entry corresponding to the presented line entry number 107 for the requester 103. The requester 103 reads the status information contained in the status entry, and in step 303, examines the status information to make a determination whether the cache line may be accessed in the manner intended by the requester 103 (step 304).

The determination in step 304 includes considering any alternative manner in which the cache line may be accessed. For example, if the requester initially intended to access the entire cache line, and if based on the status information contained in the status entry indicates some portions of the cache line is owned by another requester or invalid, then the requester may decide that accessing the valid portions only may be the most suitable manner in which the cache line may be accessed in light of the current state of the cache line. If, based on the status entry, the requester determines that there is no suitable manner in which the cache line may be accessed, then the process proceeds to step 305, in which a cache access error is indicated, and the requester may wait and read the status entry at a later time to see if the status of the cache line may have changed and/or may decide to resend the request for the cache line.

On the other hand, if it is determined that the cache line may be accessed in some manner, the requester determines, in step 306, if the manner of its intended access of the cache line requires a modification of the status bits in the status entry. For example, if the requester intends to write to a portion of the cache line, the Valid Portion bits 211 would be required to be changed to reflect the validity of the portion to be written to.

If it is determined that a modification of the status entry, in light of the intended manner of access, the requester modifies the status bits of the status entry, and writes the modified status entry to the cache status block 101 via the write port 104, and access the cache line as intended. Once the modified cache status entry is written back to the cache status block 101, the process ends in step 308.

As can be appreciated, the data structure for cache status described herein allows an efficient implementation of a large number of status bits, and provides a flexible cache access to requesters, allowing the requesters to formulate the most suitable manner in which the cache lines are accessed.

While the invention has been described with reference to the exemplary embodiments thereof, those skilled in the art will be able to make various modifications to the described embodiments of the invention without departing from the true spirit and scope of the invention. The terms and descriptions used herein are set forth by way of illustration only and are not meant as limitations. In particular, although the method of the present invention has been described by examples, the steps of the method may be performed in a different order than illustrated or simultaneously. Those skilled in the art will recognize that these and other variations are possible within the spirit and scope of the invention as defined in the following claims and their equivalents.

What is claimed is:

1. A method of providing cache status information of a plurality of cache lines in a cache memory, comprising:
providing a cache status data table having a plurality of status entries, each of said plurality of status entries corresponding to one of said plurality of cache lines in said cache memory, and each of said plurality of cache status entries having a plurality of cache status bits that indicates status of said corresponding one of said plurality of cache lines;
receiving a first cache entry line number corresponding to a first one of said plurality of cache lines from a first requester; and
allowing said first requester an access to a first requested one of said plurality of status entries that corresponds to said first cache entry line number.

2. The method of providing cache status information in accordance with claim 1, further comprising:
storing said cache data status table in a memory having one or more read ports configured to allow one or more requesters to read said plurality of cache status entries and one or more write port configured to allow said one or more requesters to write to said plurality of cache status entries.

3. The method of providing cache status information in accordance with claim 2, further comprising:
receiving a second cache entry line number corresponding to a second one of said plurality of cache lines from a second requester; and
allowing said second requester an access to a second requested one of said plurality of status entries that corresponds to said second cache entry line number concurrently with said first requester accessing said first requested one of said plurality of status entries, through at least one of said one or more read ports and said one or more write ports.

4. The method of providing cache status information in accordance with claim 2, further comprising:
examining, by said first requester, said first one of said plurality of status entries to determine whether said first one of said plurality of cache lines may be accessed in a manner intended by said first requester; and
accessing, by said first requester, if said first one of said plurality of status entries indicate that said first one of said plurality of cache lines may be accessed in a manner intended by said first requester, said first one of said plurality of cache lines in a manner intended by said first requester.

5. The method of providing cache status information in accordance with claim 4, further comprising:
accessing, by said first requester, if said first one of said plurality of status entries indicate that said first one of said plurality of cache lines may not be accessed in a manner intended by said first requester, said first one of said plurality of cache lines in an alternative manner different from that intended by said first requester.

6. The method of providing cache status information in accordance with claim 5, further comprising:
determining, by said first requester, whether said intended manner requires a modification of said first one of said plurality of status entries;
allowing, if said modification of said first one of said plurality of status entries is required, said first requester to write a modified first one of said plurality of status entries to said cache status data structure block through said one or more write ports.

7. The method of providing cache status information in accordance with claim 1, wherein said plurality of cache status bits comprises:
one or more bits indicating a current owner of said corresponding one of said plurality of cache lines; and
one or more bits indicating which portion of said corresponding one of said plurality of cache lines may be available for access.

8. An apparatus for providing cache status information of a plurality of cache lines in a cache memory, comprising:
a cache status data table having a plurality of status entries, each of said plurality of status entries corresponding to one of said plurality of cache lines in said cache memory, and each of said plurality of cache status entries having a plurality of cache status bits that indicates status of said corresponding one of said plurality of cache lines;
means for receiving a first cache entry line number corresponding to a first one of said plurality of cache lines from a first requester; and
means for allowing said first requester an access to a first requested one of said plurality of status entries that corresponds to said first cache entry line number.

9. The apparatus for providing cache status information according to claim 8, further comprising:
a memory for storing said cache data status table, said memory having one or more read ports configured to allow one or more requesters to read said plurality of cache status entries and one or more write port configured to allow said one or more requesters to write to said plurality of cache status entries.

10. The apparatus for providing cache status information according to claim 9, further comprising:
means for receiving a second cache entry line number corresponding to a second one of said plurality of cache lines from a second requester; and
means for allowing said second requester an access to a second requested one of said plurality of status entries that corresponds to said second cache entry line number concurrently with said first requester accessing said first requested one of said plurality of status entries, through at least one of said one or more read ports and said one or more write ports.

11. The apparatus for providing cache status information according to claim 9, wherein:
said first one of said plurality of status entries provides an indication whether said first one of said plurality of cache lines may be accessed in a manner intended by said first requester.

12. The apparatus for providing cache status information according to claim 11, wherein:
said one or more write ports allows said first requester to write a modified first one of said plurality of status entries to said cache status data structure block.

13. The apparatus for providing cache status information according to claim 7, wherein said plurality of cache status bits comprises:
one or more bits indicating a current owner of said corresponding one of said plurality of cache lines; and
one or more bits indicating which portion of said corresponding one of said plurality of cache line may be available for access.

14. The apparatus for providing cache status information according to claim 13, wherein said plurality of cache status bits further comprises:
one or more bits indicating a type of ownership of said owner of said corresponding one of said plurality of cache lines; and
one or more bits indicating whether a direct memory access operation involving said corresponding one of said plurality of cache lines is pending.

15. The apparatus for providing cache status information according to claim 14, wherein said plurality of cache status bits further comprises:
one or more bits indicating a last time said corresponding one of said plurality of cache lines was accessed.

16. A cache memory system, comprising:
a cache memory having a plurality of cache lines;
a cache status data table having a plurality of status entries, each of said plurality of status entries corresponding to one of said plurality of cache lines in said cache memory, and each of said plurality of cache status entries having a plurality of cache status bits that indicates status of said corresponding one of said plurality of cache lines.

17. The cache memory system according to claim 16, further comprising:
a memory for storing said cache data status table, said memory having one or more read ports configured to allow one or more requesters to read said plurality of cache status entries and one or more write port configured to allow said one or more requesters to write to said plurality of cache status entries.

18. The cache memory system according to claim 16, wherein said plurality of cache status bits comprises:
one or more bits indicating a current owner of said corresponding one of said plurality of cache lines; and
one or more bits indicating which portion of said corresponding one of said plurality of cache line may be available for access.

19. The cache memory system according to claim 18, wherein said plurality of cache status bits comprises:
one or more bits indicating a type of ownership of said owner of said corresponding one of said plurality of cache lines; and
one or more bits indicating whether a direct memory access operation involving said corresponding one of said plurality of cache lines is pending.

20. The cache memory system according to claim 19, wherein said plurality of cache status bits comprises:
one or more bits indicating a last time said corresponding one of said plurality of cache lines was accessed.
